(19) United States
(12) Patent Application Publication
(10) Pub. No.: US 2023/0359218 A1
(43) Pub. Date: Nov. 9, 2023

(54) VISUAL DRIVING ASSISTANCE SYSTEM FOR A MINING MACHINE

(71) Applicant: SANDVIK MINING AND CONSTRUCTION OY, Tampere (FI)

(72) Inventors: Jussi PUURA, Tampere (FI); Tero PIISPALA, Tampere (FI); Lauri SIIVONEN, Tampere (FI)

(21) Appl. No.: 18/025,708

(22) PCT Filed: Sep. 15, 2020
(86) PCT No.: PCT/EP2020/075784

§ 371 Date: Mar. 10, 2023

(51) Int. Cl. G05D 1/02; G06T 7/80; G06T 17/00; G06T 7/593

(52) U.S. Cl. CPC G05D 1/0274; G05D 1/0251; G06T 7/593; G06T 7/85; G06T 17/00; G05D 2201/021; G06T 2207/10012; G06T 2207/10028; G06T 2207/30252

(57) ABSTRACT

A visual driving assistance system for a mining machine includes at least one stereo camera in a calibrated location for acquiring stereo images. The mining machine has two body portions. Acquired stereo images are used in generating a three-dimensional model of the environment and the body portions of the mining machine. The three-dimensional model may be used in generating a view for the driver of the mining machine or used as such in autonomous driving arrangements.

### DESCRIPTION OF BACKGROUND

This disclosure relates to mining machines. Particularly this disclosure relates to visual driving assistant systems of a mining machine.

Mining machines are often big machines operating in tight mining tunnels or galleries. These machines have a wide variety of different tasks including, for example, quarrying, drilling and transportation. They are commonly driven by a person. The driver may be located in a cabin of the mining machine or use a remote control for controlling the mining machine. Using a remote control is particularly beneficial when the visibility from the cabin is limited. A mining machine typically comprises more than one body part. Thus, there is often a tractor or a pulling body part and at least one trailer. It is also possible that the body parts are coupled to each other but have a power train of their own.

A commonly used solution is to provide one or more cameras to provide driving assistants like in passenger cars. These cameras are typically ordinary two-dimensional camera units in a small and robust package. These cameras are typically located so that they are less prone to damage. This may be achieved, for example, by providing a protective cover or placing the camera to a cavity or similar protective form. Cameras can be used to cover blind spots or to form a 360 degree camera view showing surroundings of the passenger car. One problem with these cameras is that the view must be stretched from the images and that causes distortion in the images. These distortions in the view can be particularly problematic when two or more body parts are involved and a mining machine is driven in a narrow mining tunnel.

### SUMMARY

In the following disclosure a visual driving assistance system for a mining machine disclosed. The visual driving assistance system includes at least one stereo camera in a calibrated location for acquiring stereo images. The mining machine comprises two body portions. Acquired stereo images are then used in generating a three-dimensional model of the environment and the body portions of the mining machine. The three-dimensional model may be used in generating a view for the driver of the mining machine or used as such in autonomous driving arrangements.

In an aspect a mining machine is disclosed. The mining machine comprises a camera arrangement configured to display surroundings comprising: a body comprising a first body portion, a second body portion and an articulation between the first and the second body portion; at least one stereo camera configured to acquire one or more of stereo images into forward direction; a processing circuitry configured to: generate a three-dimensional model of the mining tunnel based on the acquired stereo images and the mining machine dimensions. It is beneficial to generate a three-dimensional model of the mining tunnel as it can be used in controlling the mining machine in difficult environments. The model may be used by a person or a autonomous operation systems.

In an implementation the processing circuitry is further configured to transmit the generated three-dimensional model to a user interface. It is beneficial to transmit the three-dimensional model or a rendering of the model to a user interface so that a person controlling the mining machine can observe the mining machine from all angles. The user interface may be in the mining machine, in a remote control in the vicinity of the mining machine or in a control room. This increases safety of the mining machine by securing safe movement of the mining machine and by managing and reducing collision risk.

In an implementation the processing circuitry is configured to generate the three-dimensional model of the mining tunnel using a plurality of from different locations acquired images, wherein the mining machine has moved in order to reach said different locations. It is beneficial to acquire images from different locations so that the model is constructed for a complete mining tunnel and also for the parts that are not visible from the first location. This way for example floor that is under the machine can be included in the model although not currently visible in cameras. This forms an element of short-term memory into the system.

In an implementation the mining machine further comprises one or more additional stereo cameras, wherein each stereo camera is in a calibrated location with regard other stereo cameras. It is beneficial use several stereo cameras that have been calibrated to each other so that the accuracy and coverage of the model is increased.

In an implementation the mining machine comprises stereo cameras in different body portions. It is beneficial have stereo cameras in different body portions as the body portions may move along a different path.

In an implementation the stereo cameras are configured to acquire stereo images in different orientations. It is beneficial acquire images in different orientations in order to increase the coverage of the model.

In an implementation the processing circuitry is configured to generate the three-dimensional model of the mining tunnel using a plurality of in different orientation acquired stereo images from at least one stereo camera pair. It is beneficial use several images acquired in different directions in order to increase the accuracy of the model.

In an implementation the processing circuitry is configured to determine the articulation angle between the first body portion and the second body portion. It is beneficial to determine the articulation angle between the body portions as when the angle and the length of the joint is known the position of the second body portion and cameras therein can be computed.

In an implementation the processing circuitry is configured to calculate new locations of stereo cameras based on the determined articulation angle. It is beneficial to calculate the locations of the stereo cameras in the second body portion so that the images of acquired by stereo cameras in different body portions can be combined.

In an implementation processing circuitry is configured generate separate three-dimensional models for each body portion and to calculate the articulation angle from the separate three-dimensional models. It is beneficial calculate the angle between the body portions when separate measurement device is not available.

In an implementation the mining machine further comprises an articulation angle indicator. It is beneficial to use an articulation angle indicator that can measure the articulation angle accurately.

In an implementation the mining machine further comprises at least one two-dimensional or thermal camera. It is beneficial use additional imaging devices to support one or more stereo cameras in generating accurate three-dimensional model and to make the model more informative by adding additional information such as color, alternative texture or temperature to it.

In an implementation the processing circuitry is configured to identify objects in the three-dimensional model. It is beneficial to identify the objects in the model so that the information may be used in controlling, particularly in case of autonomous operation of the mining machine. It is beneficial to know if the object is moving or stationary and if it is possible to drive close or if more space is required. Furthermore, sometimes it is beneficial to identify infrastructure such as chargers and similar.

In an implementation the processing circuitry is further configured to: generate a second three-dimensional model; compare the first and the second three-dimensional model; and measure a change between the first and the second three-dimensional model. It is beneficial to measure a change to an earlier generated three-dimensional model so that it can be detected if the mining tunnel has changed. This information may be used in controlling other mining machines.

In an implementation the processing circuitry is further configured to: determine if the exposure an image acquired by a stereo camera is correct; and in case of incorrect exposure to instruct the stereo camera to acquire a second stereo image, wherein the second stereo image is acquired using different exposure and/or lighting settings. It is beneficial to detect if the exposure of the acquired images is correct. When the exposure is correct the details are better visible in the images.

### BRIEF DESCRIPTION OF THE DRAWINGS

The accompanying drawings, which are included to provide a further understanding of the visual driving assistance system for a mining machine and constitute a part of this specification, illustrate examples and together with the description help to explain the principles of the visual driving assistance system for a mining machine. In the drawings:

FIG. 1 is a block diagram of an example of a mining machine with a visual driving assistance system;

FIG. 2 is an example of a method for a visual driving assistance system for a mining machine; and

FIG. 3 is an example of a method for a visual driving assistance system for a mining machine.

### DETAILED DESCRIPTION

Reference will now be made in detail to the examples which are illustrated in the accompanying drawings.

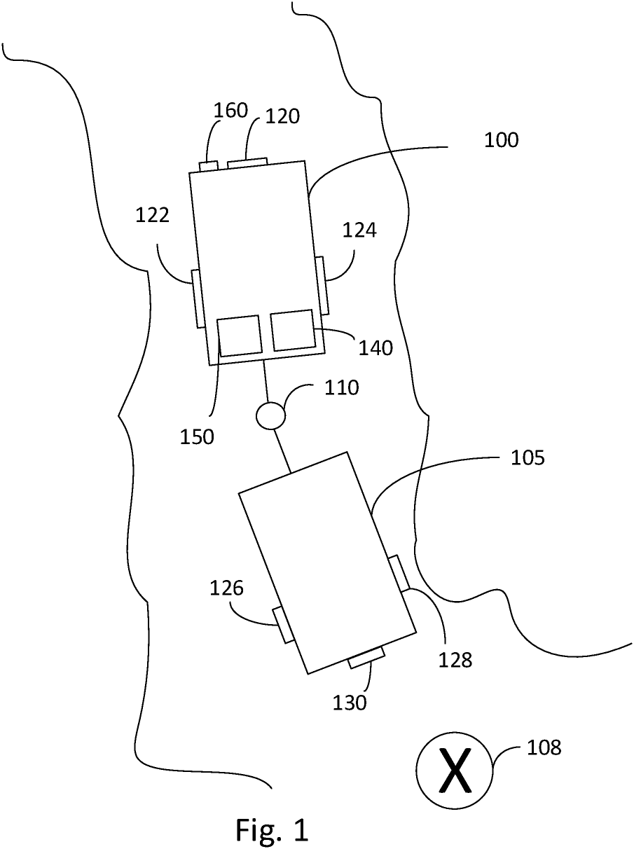

FIG. 1 discloses an example of a mining machine with a visual driving assistance system. In the example of FIG. 1 the mining machine comprises a first body portion 100 and a second body portion 105. In the example of FIG. 1 the mining machine is proceeding in a mining tunnel in direction of the first body portion 100. In the example of FIG. 1 the mining machine is remote controlled by a person 108. The mining machine may have a cabin that can be used for controlling the mining machine. In the example of FIG. 1 the controlling is done by the person 108 who has a remote controller, which is configured to communicate with a communication interface 150 of the mining machine. The remote controller may be any suitable computing device, for example, a tablet computer or a mobile phone. However, it is possible to manufacture a special purpose remote control that is durable and includes display and controls. The communication interface 150 may be a commonly used communication system such as a wireless local area network, blue tooth, local private LTE or 5G network or similar. Instead of a commonly used networking solution a special purpose radio controlling network or similar may be used. The mining machine of FIG. 1 comprises two body portions that are articulated to each other by an articulation joint 110. The number of body portions is not limited to two and it may be three or more. The communication interface 150 may be used for transmitting instructions to the second body portion. This is particularly useful when the second body portion comprises a power train of own and is used driving the mining machine backwards.

The first body portion 100 comprises a stereo camera 120 in the front part. The stereo camera 120 comprises at least two imaging units so that a stereo image can be acquired. The imaging units of the stereo camera may be calibrated with regard each other and also internally, for example, in order to decrease the lens distortion and other distortions. In the example of FIG. 1 only one stereo camera 120 is shown with forward orientation, however, there may be more than one so that stereo camera pairs improving the quality can be formed. The stereo camera 120 and other stereo cameras are provided in calibrated locations and preferably attached to the mining machine during manufacturing of the mining machine. Thus, the stereo camera system is completely calibrated during manufacturing. A recalibration may be performed, for example, when the mining machine is taken into a regular inspection.

The stereo camera 120 acquires stereo images when the mining machine proceeds in the mining tunnel. Mining tunnels are difficult environments as they may be tight and there may be rocks and other obstacles. The stereo camera 120 is configured to acquire images so that a processing circuitry 140 may generate a three-dimensional model based on the acquired images. The three-dimensional model may be done using the stereo camera 120 and a number of recently acquired images. By using older delayed images, it is possible to generate a model that shows also sections relevant to the second body portion.

In the example of FIG. 1, however, the images from the stereo camera 120 are supplemented by additional images from stereo cameras 122, 124, 126 and 130. Stereo cameras 122 and 124 are located on the sides of the first body portion. The locations are calibrated with regard each other and the stereo cameras are preferably attached to these locations already when the mining machine is manufactured. Stereo cameras 126 and 128 are located on the sides of the second body portion. The stereo camera 130 is located on the back and is of particular use when the mining machine is moving backwards. When more than one stereo camera is used the three-dimensional model can be generated immediately and there is no need to wait that the mining machine proceeds along the path so that stereo images acquired by the forward oriented camera would be sufficient in order to facilitate the generation of the three-dimensional model. Furthermore, a plurality of cameras provides a possibility to acquire images from different angles and this improves the quality of the coverage.

In the example of FIG. 1 the processing circuitry 140 is configured to generate a three-dimensional model that is based on the acquired images and the dimensions of the mining machine. The three-dimensional model comprises the geometry of the mining tunnel and objects that are located in the tunnel including the mining machine itself. The mining machine is modeled such that the first and the second body portions are in correct locations with regard the tunnel. The modelling is possible because the locations of the stereo cameras are known. Furthermore, the generation of the three-dimensional model may be supported by maps, possibly of high precision, that may be generated using three-dimensional models from one or more mining machines. This is possible because in many parts the mining tunnel does not change over the time but the walls and the roof are stable. When high precision maps or three-dimensional models of the mine already exists it can be used as a support when generating a model of the changing parts, which include other traffic and other possible obstacles.

Using the three-dimensional model it is possible to render a three-dimensional view illustrating the mining tunnel. Alternatively, or in addition, the model may be used for facilitating autonomous driving in the tunnel. In such case the rendered view can be used in monitoring the performance of the mining machine.

As explained above the locations of stereo cameras are known because of the made factory calibration. This provides a possibility to combine stereo images acquired by different cameras. Thus, two or more images acquired using different stereo cameras seeing a same object or a feature can be combined in order to improve the accuracy of the three-dimensional model. Even if the example of FIG. 1 shows only one stereo camera per orientation, it should be understood that there may be more stereo cameras and the stereo images acquired by them can be easily combined.

In the example of FIG. 1 the articulation angle can be detected by using a measuring device for measuring the articulation angle of the articulation joint 110. The articulation angle can be used in computing the actual locations of stereo cameras. When the mining machine proceeds along a path in the mine and makes turns, the positions of different body parts change in relation to each other. This naturally causes a similar change in locations of stereo cameras as they move according to the respective body part. When the articulation angle is measured the information can be used for computing the locations of stereo cameras so that one stereo camera in a first body portion can be used together with another stereo camera in a second body portion when acquiring material for three-dimensional model generation.

In the example of FIG. 1 the mining machine comprises a measuring device or indicator for measuring the articulation angle. Instead of using a separate measurement device it is possible to compute the articulation angle using acquired images. Furthermore, there may be separate cameras or sensors that are configured to acquire images of a different body portion. For example, the first body portion may have specific cameras or distance sensors that are configured to measure the distance between different body portions. Then, a distance or a plurality of distance measurements can be used in retrieving the corresponding angle from a database or other data structure capable of storing a look-up table. Thus, any suitable means for estimating or accurately measuring the articulation angle may be used.

In a further example the three-dimensional model generated based on the stereo images is supplemented by using additional image material from one or more additional imaging devices. These additional imaging devices may be two-dimensional digital cameras or thermal cameras. Instead of a two-dimensional camera the stereo camera may be used to acquire two-dimensional images. The mining machine, however, may have additional cameras that are used primarily for other reasons and the additional images may be used to improve the model particularly when objects, persons or parts of the mining machine are blocking the view. When the three-dimensional model of the environment has been created two-dimensional material or thermal measurement can be used to supplement the model. This provides a possibility to show a realistic view of the environment to the driver. In addition to a realistic view an augmented reality view may be shown, wherein the augmented reality view may comprise, for example, driving or navigation instructions. In the example of FIG. 1 only one two-dimensional camera 160 is shown. The two-dimensional camera of FIG. 1 is arranged in association with the forward oriented stereo camera 120. A similar two-dimensional camera may be associated also with each of the stereo cameras. The two-dimensional camera needs not necessarily to be calibrated similarly as the stereo cameras. The images acquired by the two-dimensional cameras can be adapted to fit the three-dimensional model. This can be done, for example, by detecting the relevant edges or other features and then by mapping the two-dimensional image on the three-dimensional model in order to produce a photorealistic view. This step is naturally not necessary when the two-dimensional images have been acquired using the stereo camera. The photorealistic view is beneficial as the driver perceives the environment as it is.

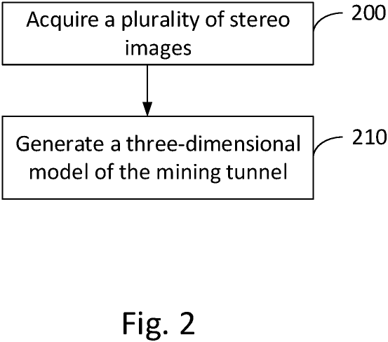

In FIG. 2 an example of a method in a visual driving assistance system is disclosed. The method is used in a mining machine having a body comprising a first body portion, a second body portion and an articulation between the first and the second body portion. In the example of FIG. 2 the first body comprises at least one stereo camera. In the method first a plurality of stereo images into forward direction are acquired, step 200. Then, three-dimensional model of the mining tunnel based on the acquired plurality of stereo images and the mining machine dimensions is generated, step 210. This three-dimensional model may then be used in a user interface or/and in autonomous driving arrangements. The stereo camera may be configured to acquire stereo images according to a particular interval or continuously.

The method provides a possibility to model, for example, a mining tunnel and a mining machine in it. From the generated three-dimensional model it is possible to see exactly how the mining machine is located in the mining tunnel so that the driver can avoid collisions with tunnel walls, other traffic, loose objects and humans inside the tunnel. The three-dimensional model provides an undistorted view without a need to stretch the acquired images.

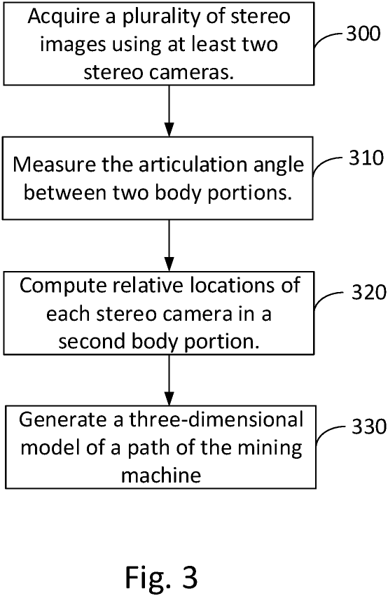

In FIG. 3 an example of a method in a more advanced visual driving assistance system is disclosed. The method is used in a mining machine having a body comprising a first body portion, a second body portion and an articulation between the first and the second body portion. The mining machine further comprises means for measuring the articulation angle between the first and second portion. In the example of FIG. 4 the mining machine comprises more than one stereo camera for acquiring images.

The method is initiated by acquiring a plurality of stereo images, step 300. Stereo images are acquired using a plurality of stereo cameras that are located in different calibrated locations. In the example of FIG. 3 stereo cameras are distributed so that both of body portions comprise at least one stereo camera. Because of this the stereo cameras are not always relatively in same locations as they were when they were installed at their calibrated locations. This is caused by the fact that the articulated body is not always in a same position, which is typically no articulation or articulation angle zero, as it was when the calibration was done. Thus, the method includes measuring the articulation angle between the body portions, step 310.

When the original locations and the articulation angle are known the new positions can be easily computed by using trigonometry, kinematic model of the machine or similar, step 320. Now, when the locations of each of the cameras is known, a three-dimensional model can be generated as locations of observed points can be computed based on the known locations of stereo cameras, step 330.

In the above the three-dimensional model is generated for a mining machine comprising two body portions, however, it is possible to generate similar models for mining machines with three or more portions. This requires that the dimensions of body portions and both articulation angles are known. However, it is also possible to implement embodiments, wherein all body portions do not have stereo cameras but the three-dimensional model is generated, for example, using the first and last body portions or the first and the second. In order to model the location of a body portion accurately it is beneficial to know the articulation angle exactly, however, this is not always necessary. For example, when the third body portion is used only occasionally, a third body portion without stereo cameras can be connected to a second body portion. The relative position of the third body portion can be computed if there is a articulation angle measurement device between the second and third body portion or there is a camera, stereo camera or other optical sensor that can be used in estimating the articulation angle between the second and the third body portion. If the third body portion does not have imaging equipment or means for determining the articulation angle between the second and third body portions the location of the third body portion may be simulated and included in the three-dimensional model.

As in the earlier examples the generated three-dimensional model may be rendered to be shown in a user interface or used as such for autonomous driving functionality, wherein the autonomous driving may be partially or fully self-driving.

In the examples above a plurality of images are acquired using one or more stereo cameras. These stereo cameras are used to acquire images in mining tunnels that have variable lighting conditions and moving machines and other objects can cause significant shades. Thus, it may be necessary to use automatic exposure arrangements independently for each of the cameras. Furthermore, after acquiring a stereo image or an additional image, a post processing may be used to determine if the exposure was correct or not. In some situations, an over exposed image may be corrected using a post processor, however, if the acquired image is burned out some of the details may not be visible in the image and they may not be extracted using common post processing means. In a such situation, it may be necessary to acquire new image. The acquiring process may required changing configuration of lighting devices. For example, when the mining machine is proceeding near the wall side lights might cause over exposure and burning. In a such situation some lights may be turned off or dimmed. Accordingly, when the image is under exposed the lighting may be increased or a flash light may be used.

The above-mentioned method may be implemented as computer software which is executed in a computing device, which may be integrated at the visual driving assistance system for a mining machine. When the software is executed in a computing device it is configured to perform the above described inventive method. The software is embodied on a computer readable medium so that it can be provided to the computing device, such as the processing circuitry 140 of FIG. 1.

As stated above, the components of the examples can include computer readable medium or memories for holding instructions programmed according to the teachings of the present inventions and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the driving assistance system may be implemented in various ways. The driving assistance system and its embodiments are thus not limited to the examples described above; instead they may vary within the scope of the claims.

1. A mining machine having a camera arrangement configured to display surroundings of a mining tunnel, the mining machine comprising:
a body including a first body portion, a second body portion and an articulation between the first and the second body portion;
at least one stereo camera configured to acquire one or more of stereo images in a forward direction; and
a processing circuitry configured to generate a three-dimensional model of the mining tunnel based on the acquired stereo images and dimensions of the mining machine .

2. The mining machine according to claim 1, wherein the processing circuitry is further configured to transmit the generated three-dimensional model to a user interface.

3. The mining machine according to claim 1, wherein the processing circuitry is configured to generate the three-dimensional model of the mining tunnel using acquired images from a plurality of different locations, wherein the mining machine has moved in order to reach said different locations.

4. The mining machine according to claim 1, wherein the at least one stereo camera comprises a plurality of stereo cameras, wherein each stereo camera is in a calibrated location with regard other stereo cameras.

5. The mining machine according to claim 4, wherein the stereo cameras are located in different body portions.

6. The mining machine according to claim 5, wherein the stereo cameras are configured to acquire stereo images in different orientations.

7. The mining machine according to claim 6, wherein the processing circuitry is configured to generate the three-dimensional model of the mining tunnel using a plurality of the acquired stero images in different forientations from at least one stereo camera pair.

8. The mining machine according to claim 1, wherein the processing circuitry is configured to determine an articulation angle between the first body portion and the second body portion.

9. The mining machine according to claim 8, wherein the at least one stereo camera comprises a plurality of stereo cameras, and wherein the processing circuitry is configured to calculate new locations of stereo cameras based on the determined articulation angle.

10. The mining machine according to claim 8, wherein the processing circuitry is configured to generate separate three-dimensional models for each body portion and to calculate the articulation angle from the separate three-dimensional models.

11. The mining machine according to claim 8, further comprising an articulation angle indicator.

12. The mining machine according to claim 1, further comprising at least one two-dimensional or thermal camera.

13. The mining machine according to claim 12, wherein the processing circuitry is configured to identify objects in the three-dimensional model.

14. The mining machine according to claim 1, wherein the processing circuitry is further configured to:
generate a second three-dimensional model;
compare the first and the second three-dimensional model; and
measure a change between the first and the second three-dimensional model.

15. The mining machine according to claim 1 -14, wherein the processing circuitry is further configured to:
determine if an exposure of an image acquired by the at least one stereo camera is correct; and
in case of an incorrect exposure, to instruct the stereo camera to acquire a second stereo image, wherein the second stereo image is acquired using different exposure and/or lighting settings.
